(19) United States
(12) Patent Application Publication
(10) Pub. No.: US 2026/0268626 A1
(43) Pub. Date: Sep. 10, 2026

(54) SYSTEMS AND METHODS FOR CORRECTING ROTATION IN IMAGES OBTAINED BY A CAMERA ASSEMBLY OF A REFRIGERATOR APPLIANCE

(71) Applicant: Haier US Appliance Solutions, Inc., Wilmington, DE (US)

(72) Inventor: Jacob Lawless, Louisville, KY (US)

(21) Appl. No.: 19/070,622

(22) Filed: Mar. 5, 2025

(51) Int. Cl. G06V 10/24; F25D 29/00; G06V 10/774; G06V 10/82; G06V 20/52; G06V 20/68

(52) U.S. Cl. CPC G06V 10/245; F25D 29/00; G06V 10/242; G06V 10/774; G06V 10/82; F25D 2700/06; G06V 20/52; G06V 20/68

(57) ABSTRACT

A refrigerator appliance may include a cabinet that may define a chilled chamber. The refrigerator appliance may include a camera assembly mounted to the cabinet. The refrigerator appliance may include a controller operably coupled to the camera assembly. The controller may be operable for: obtaining one or more images of the chilled chamber using the camera assembly, determining rotation relative to a fiducial reference of the refrigerator appliance in the one or more images, and generating a corrected image based on determining rotation relative to the fiducial reference in the one or more images.

### FIELD OF THE DISCLOSURE

The present subject matter relates generally to a refrigerator appliance, and more particularly to systems and methods for operating a camera assembly of a refrigerator appliance.

### BACKGROUND OF THE DISCLOSURE

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber that are designed to facilitate storage of food items therein. Such storage components can include racks, bins, shelves, or drawers that receive food items and assist with organizing and arranging such food items within the chilled chamber.

Certain conventional refrigerator appliances include cameras that are configured for obtaining images within the chilled chamber. The images obtained by the camera may be utilized in a variety of operational tasks for the refrigerator appliance. However, such cameras can have numerous drawbacks. For example, maintaining proper alignment of the camera, for instance, relative to the cabinet of the refrigerator appliance, across the life span of the refrigerator appliance can be difficult.

Accordingly, systems and methods for a refrigerator appliance that obviate one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a refrigerator appliance is provided. The refrigerator appliance may include a cabinet that may define a chilled chamber. The refrigerator appliance may include a camera assembly mounted to the cabinet. The refrigerator appliance may include a controller operably coupled to the camera assembly. The controller may be operable for: obtaining one or more images of the chilled chamber using the camera assembly, determining rotation relative to a fiducial reference of the refrigerator appliance in the one or more images, and generating a corrected image based on determining rotation relative to the fiducial reference in the one or more images.

In one exemplary aspect of the present disclosure, a method for correcting rotation in images obtained by a camera assembly of a refrigerator appliance is provided. The method may include obtaining one or more images of a chilled chamber of the refrigerator appliance using the camera assembly. The method may include determining rotation relative to a fiducial reference of the refrigerator appliance in the one or more images. The method may include generating a corrected image based on determining rotation relative to the fiducial reference in the one or more images.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to one or more exemplary embodiments of the present subject matter.

FIG. 2 provides a front view of the exemplary refrigerator appliance of FIG. 1, with the doors of the fresh food chamber shown in an open position.

FIG. 3 provides a schematic side view of a refrigerator appliance including a camera oriented in a first position according to one or more exemplary embodiments of the present subject matter.

FIG. 4 provides a schematic side view of a refrigerator appliance including a camera oriented in a second position according to one or more exemplary embodiments of the present subject matter.

FIG. 5 provides an image obtained using the exemplary camera of FIG. 3 in the first position according to an exemplary embodiment of the present subject matter.

FIG. 6 provides an image obtained using the exemplary camera of FIG. 4 in the second position according to an exemplary embodiment of the present subject matter.

FIG. 7 provides a plurality of training images obtained using the exemplary camera of FIG. 3 and a plurality of corresponding corrected images that have been rotated based on an image rotation correction model according to one or more exemplary embodiments of the present subject matter.

FIG. 8 provides a pair of modified images according to one or more exemplary embodiments of the present subject matter.

FIG. 9 provides a flow diagram of an exemplary method for operating a camera assembly of a refrigerator appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

In general, the present disclosure provides systems and methods for operating a camera assembly of a refrigerator appliance. Such a camera assembly may include a camera mounted to a cabinet of the refrigerator appliance and configured for obtaining one or more images. The camera can include a field of view in or around chilled chamber(s) of the refrigerator appliance such that the one or more images obtained are of a target area in the chilled chamber(s) or a target area around the chilled chamber(s). Notably, the camera assembly may utilize an image rotation correction model that is configured for determining rotation (e.g., relative to a fiducial reference or predetermined angle in the image) in the one or more images and correcting (e.g., rotating) the image such that a corrected image produced includes approximately zero degrees of rotation (e.g., relative to the fiducial reference or predetermined angle in the image). The image rotation correction model can utilize a machine learning image recognition process that can be actively trained on various degrees of rotation (e.g., in one or more training images). When compared to existing camera assemblies for refrigerator appliances, the exemplary camera assembly advantageously produces images that include an accurate (e.g., a full) representation of the contents in the chilled chamber(s) of the refrigerator appliance.

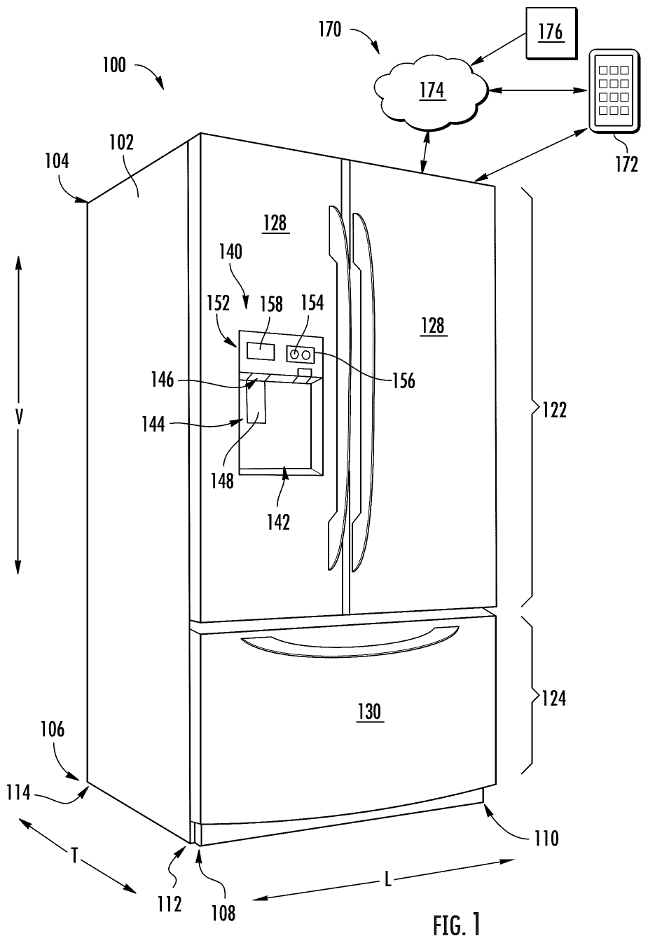

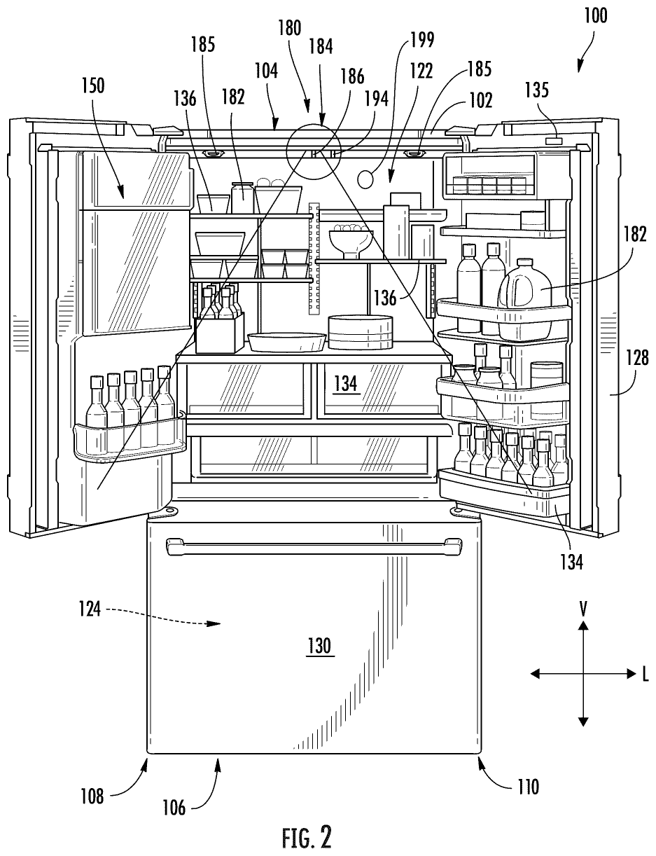

Referring now to the figures, FIG. 1 provides a perspective view of an exemplary refrigerator appliance 100 and FIG. 2 illustrates refrigerator appliance 100 with some of the doors in the open position. As illustrated, refrigerator appliance 100 generally defines a vertical direction V, a lateral direction L, and a transverse direction T, each of which is mutually perpendicular, such that an orthogonal coordinate system is generally defined.

In some embodiments, refrigerator appliance 100 includes a cabinet 102 that is generally configured for containing or supporting various components of refrigerator appliance 100 and which may also define one or more internal chambers or compartments of refrigerator appliance 100. In this regard, as used herein, the terms “cabinet,” “housing,” or the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 100.

Cabinet 102 may define chilled chambers for receipt of food items for storage. In particular, cabinet 102 may define a fresh food chamber 122 positioned at or adjacent top 104 of cabinet 102 and a freezer chamber 124 arranged at or adjacent bottom 106 of cabinet 102. As such, refrigerator appliance 100 may generally be referred to as a bottom mount refrigerator. It is recognized, however, that the benefits of the present disclosure apply to other types and styles of refrigerator appliances such as, e.g., a top-mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 may be rotatably hinged to an edge of cabinet 102 for selectively accessing fresh food chamber 122. In addition, a freezer door 130 may be arranged below refrigerator doors 128 for selectively accessing freezer chamber 124. Freezer door 130 may be coupled to a freezer drawer slidably mounted within freezer chamber 124. In general, refrigerator doors 128 may form a seal over a front opening 132 defined by cabinet 102 (e.g., extending within a plane defined by the vertical direction V and the lateral direction L). In this regard, a user may place items within fresh food chamber 122 through front opening 132 when refrigerator doors 128 are open and may then close refrigerator doors 128 to facilitate climate control. Refrigerator doors 128 and freezer door 130 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components may be configured for receipt of food items (e.g., beverages or solid food items) and may assist with organizing such food items. Bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

The refrigerator appliance 100 may include a door position sensor 135 operably coupled to a door (e.g., refrigerator doors 128) of the refrigerator appliance 100. The door position sensor 135 may be configured to detect when the door is in a closed position or an open position. For example, the door position sensor 135 may include or be provided as a mechanical plunger switch, a reed switch, a Hall-effect sensor, a motion sensor, or the like. The door position sensor 135 may be in operative communication with a controller, such as controller 156 described in more detail below, of the refrigerator appliance 100. In this regard, when the door position sensor 135 is tripped, actuated, or otherwise triggered, a signal corresponding to the position of the door may be transmitted to the controller.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 may generally be configured for dispensing liquid water or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 may be defined on a front side 112 of refrigerator appliance 100 such that a user may operate dispensing assembly 140 without opening refrigerator door 128. In addition, dispenser recess 142 may be positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 may include an ice dispenser 144 that may include a discharging outlet 146 for discharging ice from dispensing assembly 140. An actuating mechanism 148, shown as a paddle, may be mounted below discharging outlet 146 for operating ice or water dispenser 144. In alternative exemplary embodiments, any suitable actuating mechanism may be used to operate ice dispenser 144. For example, ice dispenser 144 may include a sensor (such as an ultrasonic sensor) or a button rather than the paddle. Discharging outlet 146 and actuating mechanism 148 are an external part of ice dispenser 144 and may be mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 may be provided for controlling the mode of operation. For example, control panel 152 may include one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156 and may display information in response to signals from controller 156.

As used herein, “processing device” or “controller” may refer to one or more microprocessors or semiconductor devices and is not restricted necessarily to a single element. The processing device may be programmed to operate refrigerator appliance 100, dispensing assembly 140, vision system 180 (e.g., described in more detail below), or other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible by a processing device, including instructions that can be executed by processing device. Optionally, the instructions can be software or any set of instructions or data that when executed by the processing device, cause the processing device to perform operations.

Referring still to FIG. 1, a schematic diagram of an external communication system 170 will be described according to an exemplary embodiment of the present subject matter. In general, external communication system 170 may be configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 170 may be used to transfer data or other information to improve performance of one or more external devices or appliances or improve user interaction with such devices.

For example, external communication system 170 may permit controller 156 of refrigerator appliance 100 to communicate with a separate device external to refrigerator appliance 100, referred to generally herein as an external device 172. As described in more detail below, these communications may be facilitated using a wired or wireless connection, such as via a network 174. In general, external device 172 may be any suitable device separate from refrigerator appliance 100 that is configured to provide or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with refrigerator appliance 100 or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information. According to exemplary embodiments, remote server 176 may be configured to receive, analyze, or modify images obtained by vision system 180, e.g., to facilitate inventory analysis.

In general, communication between refrigerator appliance 100, external device 172, remote server 176, or other user devices or appliances may be carried using any type of wired or wireless connection and using any suitable type of communication network, non-limiting examples of which are provided below. For example, external device 172 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring now generally to FIG. 2, refrigerator appliance 100 may further include a vision system 180 that is generally configured to monitor one or more chambers of refrigerator appliance 100, e.g., to monitor the addition or removal of inventory within the one or more chambers of refrigerator appliance 100, to monitor storage features, such as bins and/or drawers within the one or more chambers, or the like. More specifically, as described in more detail below, vision system 180 may include a plurality of sensors, cameras, or other detection devices that are used to monitor fresh food chamber 122, for instance, to detect objects (e.g., objects 182) that are positioned in or removed from fresh food chamber 122, to monitor storage features within the fresh food chamber 122, or the like.

In this regard, vision system 180 may use data from each of these devices to obtain a complete representation or knowledge of the identity, position, or other qualitative or quantitative characteristics of objects 182 within fresh food chamber 122. Although vision system 180 is described herein as monitoring fresh food chamber 122 for the detection of objects 182, it should be appreciated that aspects of the present subject matter may be used to monitor objects or items in any other suitable appliance, chamber, etc.

As shown schematically in FIG. 2, vision system 180 may include a camera assembly 184 that is generally positioned and configured for obtaining images of refrigerator appliance 100 during operation. Specifically, according to the illustrated embodiment, camera assembly 184 includes one or more cameras 186 that are mounted to cabinet 102, to doors 128, or are otherwise positioned in view of fresh food chamber 122. Although camera assembly 184 is described herein as being used to monitor fresh food chamber 122 of refrigerator appliance 100, it should be appreciated that aspects of the present subject matter may be used to monitor any other suitable regions of any other suitable appliance, such as freezer chamber 124. As best shown in FIG. 2, a camera 186 of camera assembly 184 is mounted to cabinet 102 at front opening 132 of fresh food chamber 122 and is oriented to have a field of view directed across front opening 132 or into fresh food chamber 122.

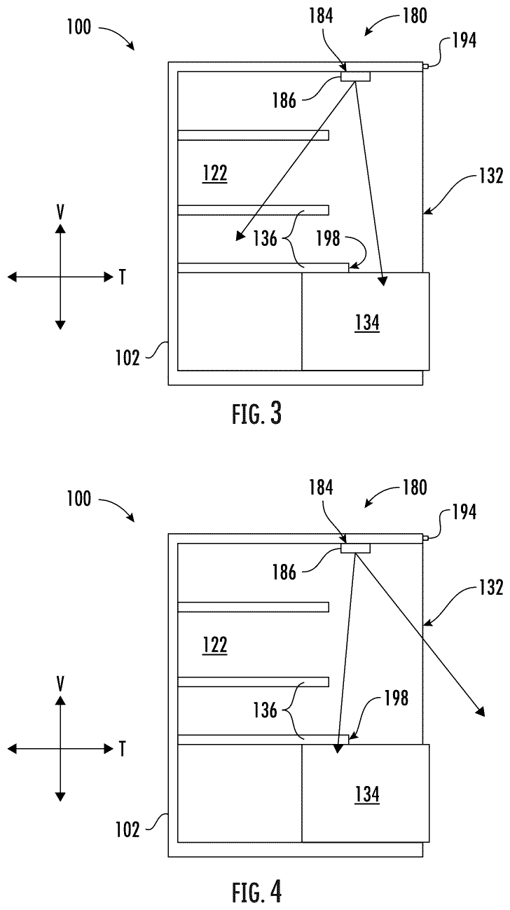

Referring now to FIGS. 3 through 6, the camera 186 may be rotatable between distinct or predetermined positions, such as a first position and a second position. For example, FIG. 3 schematically illustrates camera 186 rotated to a first position that is generally oriented rearward relative to cabinet 102, e.g., directed more toward rear side 114 or into fresh food chamber 122. By contrast, FIG. 4 schematically illustrates camera 186 rotated to a second position that is generally oriented forward relative to cabinet 102, e.g., directed more toward front side 112 or toward front opening 132 into fresh food chamber 122.

Although camera 186 is illustrated herein as being pivoted between the two distinct positions (e.g., the first position and the second position), it should be appreciated that aspects of the present subject matter may be applicable to a camera that is pivotable between any other suitable range or number of intermediate positions. For example, according to example embodiments, the pivot angle is defined between a focal point/line of the camera assembly in the first position and a focal point/line of the camera in the second position. According to example embodiments, the pivot angle is between about 5 degrees and 45 degrees, between about 10 degrees and 30 degrees, or about 20 degrees.

In addition, according to example embodiments, camera 186 is manually adjustable by a user of refrigerator appliance 100. In this regard, depending on customer preference, the user may manually move camera 186 into the first position, the second position, or some other suitable position/viewing angle. However, it should be appreciated that according to alternative embodiments, this movement may be automated, e.g., by a drive motor or some other suitable positioning mechanism. For example, a user could interact within control panel 152 (or provide input via external device 172) to specify the desired camera position and a drive motor could pivot camera 186 in accordance with the user's instructions.

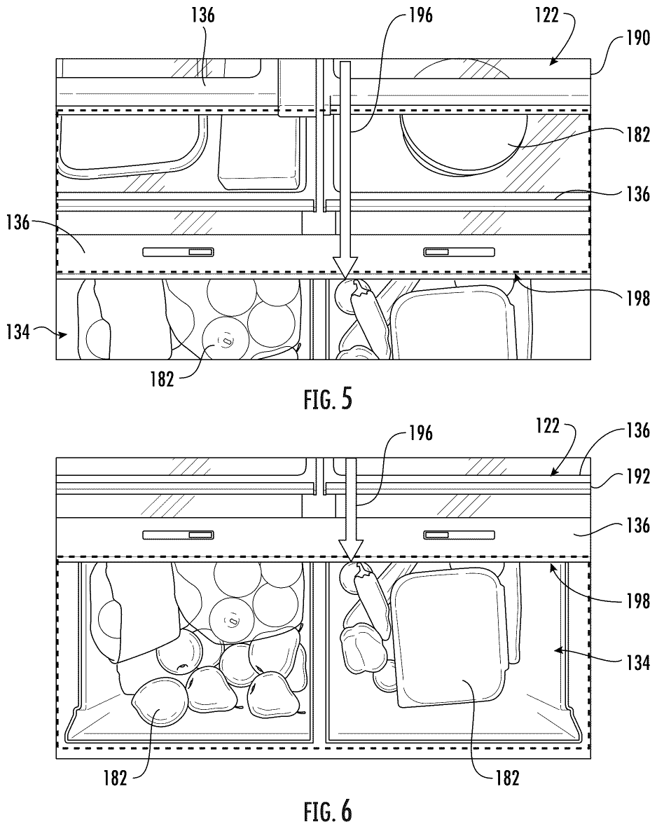

FIG. 5 illustrates an example image 190 obtained when camera 186 is in the first position (e.g., as shown in FIG. 3). In this regard, the primary objects 182 within the field of view of camera 186 in this position may be on shelf 136 (or more specifically, lower shelf 136). By contrast, FIG. 6 illustrates an example image 192 obtained when camera 186 is in the second position (e.g., as shown in FIG. 4). In this regard, the primary objects 182 within the field of view of camera 186 in this position may be within an open lower bin 134. As explained in more detail below, aspects of the present subject matter are generally directed to improving the operation and output of camera assembly 184 when camera 186 is positioned in one of multiple positions for providing the user with more useful information or images.

The camera 186 may obtain one or more still images, one or more video clips, or any other suitable type and number of images suitable. In some embodiments, the camera 186 continuously obtains images. For example, the camera 186 may continuously obtain images such that the camera may actively “stream” the fridge environment (e.g., without an external signal that may trigger the stream or live video capture). In some other embodiments, the camera 186 obtains images upon any suitable trigger, such as a time-based imaging schedule (e.g., one or more predetermined time intervals) where camera assembly periodically images and monitors fresh food chamber, such as when the door is in the open position.

Although a single camera 186 is illustrated in FIG. 2, it should be appreciated that camera assembly 184 may include a plurality of cameras 186 disposed at the cabinet 102, wherein each of the plurality of cameras 186 may have a specified monitoring zone or range positioned around fresh food chamber 122. In this regard, for example, the field of view of each camera 186 may be limited to or focused on a specific area within fresh food chamber 122. For example, an vision system 180 may include a plurality of cameras 186 that are mounted to a sidewall of fresh food chamber 122, a wall of the cabinet 102 outside of the fresh food chamber 122 (e.g., wherein the camera 186 has a specified monitoring zone of the fresh food chamber, such as a field of view directed into the fresh food chamber 122.) and may be spaced apart along the vertical direction V to cover different monitoring zones.

Notably, however, it may be desirable to position each camera 186 proximate front opening 132 of fresh food chamber 122 and orient each camera 186 such that the field of view is directed into fresh food chamber 122. In this manner, privacy concerns related to obtaining images of the user of the appliance 100 may be mitigated or avoided altogether. According to exemplary embodiments, camera assembly 184 may be used to facilitate an inventory management process for refrigerator appliance 100. As such, each camera 186 may be positioned at an opening to fresh food chamber 122 to monitor food items (identified generally as objects 182) that are being added to or removed from fresh food chamber 122 or may monitor such objects 182 after being stored within fresh food chamber 122.

According to still other embodiments, each camera 186 may be oriented in any other suitable manner for monitoring any other suitable region within or around refrigerator appliance 100. It should be appreciated that according to alternative embodiments, camera assembly 184 may include any suitable number, type, size, and configuration of camera(s) 186 for obtaining images of any suitable areas or regions within or around refrigerator appliance 100. In addition, it should be appreciated that each camera 186 may include features for adjusting the field of view or orientation.

It should be appreciated that the images obtained by camera assembly 184 may vary in number, frequency, angle, resolution, detail, etc. in order to improve the clarity of the particular regions surrounding or within refrigerator appliance 100. In addition, according to exemplary embodiments, controller 156 may be configured for illuminating the chilled chamber using one or more light sources 185 prior to obtaining images. The one or light sources 185 may emit light to illuminate the fresh food chamber 122 such as when the refrigerator door 128 are in the open position, respectively. In some embodiments, the light sources 185 are configured as alert components of the refrigerator appliance 100. For instance, the light sources 185 may be configured to perform a responsive action when a time-out condition of a door alarm is met (e.g., described in more detail below). In particular, the responsive action may include dimming or brightening the light sources 185 in response to the time-out condition being met. In this regard, the light sources 185 may be utilized to alert a user that a time-out condition of the door alarm has been met.

Notably, controller 156 of refrigerator appliance 100 (or any other suitable dedicated controller) may be communicatively coupled to camera assembly 184 and may be programmed or configured for analyzing the images obtained by camera assembly 184, e.g., in order to identify items being added or removed from refrigerator appliance 100, to monitor storage features within the refrigerator appliance 100, or the like, such as described in detail below.

In general, controller 156 may be operably coupled to camera assembly 184 for analyzing one or more images obtained by camera assembly 184 to extract useful information regarding objects 182 located within fresh food chamber 122. In this regard, for example, images obtained by camera assembly 184 may be used to identify a product, monitor motion within the fresh food chamber 122, such as motion of the product or motion of a user within the fresh food chamber, or determine rotation within the images. Notably, this analysis may be performed locally (e.g., on controller 156) or may be transmitted to a remote server (e.g., remote server 176 via external communication network 170) for analysis. Such analysis is intended to facilitate an improved user experience.

In some cases, over a life span of the refrigerator appliance 100, the camera 186 of the camera assembly 184 may become misaligned relative to the cabinet 102. For example, the camera 186 may be moved (e.g., rotated) to a non-distinct position of the camera. In such cases, the images obtained by the camera may have a slight degree of rotation, for instance, relative to a fiducial reference, such as a front edge 198 of bottom shelf 136, or predetermined angle within the field of view of the camera 186. For example, during installation of the camera 186, an operator may unintentionally misalign the camera 186 relative to the cabinet 102. As another example, after installation of the camera 186, a user of the refrigerator appliance may interact with (e.g., manipulate, such as unintentionally) the camera 186 and misalign the camera 186 relative to the cabinet. Images including rotation relative to a fiducial reference or predetermined angle may reduce the refrigerator appliances 100 ability to accurately identify items being added or removed from the refrigerator appliance 100, amongst other things. For instance, images including rotation relative to a fiducial reference or predetermined angle may unintentionally miss contents of food items being added or removed from the refrigerator appliance, amongst other things. Accordingly, the present subject matter provides systems and methods for advantageously correcting skewed or rotated images obtained with the camera 186 (e.g., when compared to existing camera assemblies that are not operable for correcting skewed or rotated images).

For instance, the controller 156 may use an image rotation correction model to detect rotation in an image and correct the rotation in the images obtained by the camera 186 (e.g., rotate the image according to the detected rotation to produce approximately zero degrees of rotation in the image). As will be appreciated in more detail below, the image rotation correction model may utilize any suitable image analysis technique, image decomposition, image segmentation, image processing, or the like to detect and correct rotation present within image obtained by the camera 186.

As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor a rotation in images obtained by the camera 186. It should be appreciated that this image analysis or processing may be performed locally (e.g., by controller such as controller 156 described in more detail below or remotely) (e.g., by offloading image data to a remote server or network such as network 1100 described in more detail below).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to detect rotation in an image relative to a fiducial reference or predetermined angle, to identify or monitor storage features, to identify movement, the presence of a particular object, the existence of a certain condition, or the like. For example, one or more reference images may be obtained when a particular condition exists, and these references images may be stored for future comparison with images obtained during appliance operation. Similarities or differences between the reference image and the obtained image may be used to extract useful information for improving appliance performance.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller 156 based on one or more captured images from one or more optical instruments such as the camera assembly 186). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

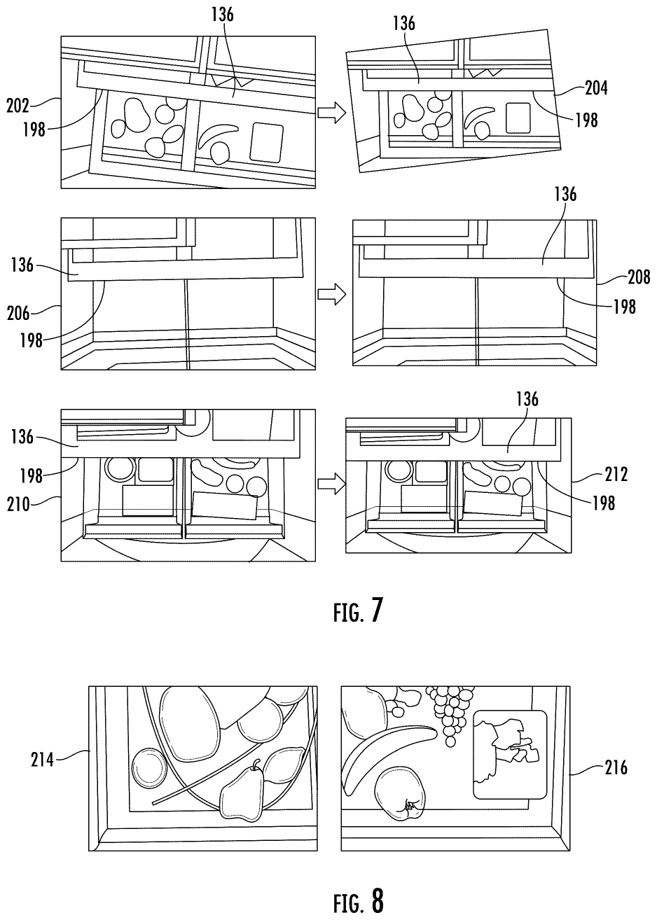

It should be appreciated that the machine learning image recognition models, such as the image rotation correction model, may be actively trained by the appliance with new images (e.g., training images), may be supplied with training data from the manufacturer or from another remote source, or may be trained in any other suitable manner. For example, referring now briefly to FIG. 7, one or more training images, such as training images 202, 206, and 210, may be supplied to a machine learning image recognition model, such as the image rotation correction model, to actively train the machine learning image recognition model. The training images 202, 206, and 210 each include a predetermined degree of rotation relative to a fiducial reference or edge (e.g., predetermined fixed reference point or edge of a shelf or drawer) or a predetermined angle (e.g., an angle deemed as a zero point) in the image, for instance, relative to the front edge 198 of bottom shelf 136. For example, the training image 202 may include approximately 6.3 degrees of rotation relative to the fiducial reference or the predetermined angle, the training image 206 may include approximately 1 degree of rotation relative to the fiducial reference or the predetermined angle, and the training image 210 may include approximately 0.25 degrees of rotation relative to the fiducial reference or to the predetermined angle. According to exemplary embodiments, this image recognition process relies at least in part on a neural network trained with a plurality of images of the chilled chamber including varying degrees of rotation. This training data (e.g., the one or more training images) may be stored locally or remotely and may be communicated to a remote server for training other appliances and models. According to exemplary embodiments, it should be appreciated that the machine learning models may include supervised or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

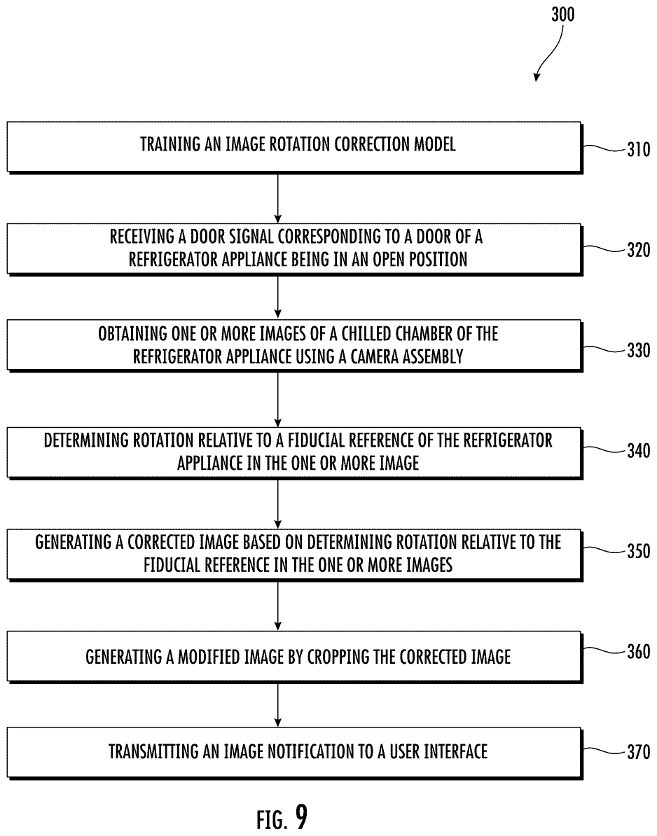

It should be appreciated that image processing and machine learning image recognition processes may be used together to facilitate improved image analysis, rotation detection and correction, or to extract other useful qualitative or quantitative data or information from the one or more images that may be used to improve the operation or performance of the appliance. For instance, as illustrated in FIG. 7, the one or more training images may be processed with the image rotation correction model to produce one or more corrected images (e.g., corrected images 204, 208, and 212, respectively) that include approximately zero degrees of rotation relative to a fiducial reference or a predetermined angle in the image. As will be appreciated in more detail below, these corrected images may advantageously be utilized in the generation of modified images that may be, amongst other things, displayed to a user. For example, referring now to FIG. 8, one or more modified images may be generated based on the one or more corrected images produced by the image rotation correction model. As shown in FIG. 8, a left modified image 214 and a right modified image 216 that may correspond to left and right portions of the lower bin 134, respectively, in the corrected image 204 are provided. As will be appreciated in more detail below, the modified images may be transmitted to a user interface (e.g., display 158, a display of external device, 172, or the like), for instance, for display to a user of the refrigerator appliance 100.

Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

Now that the construction and configuration of refrigerator appliance 100 and camera assembly 184 have been presented according to an exemplary embodiment of the present subject matter, an exemplary method 300 for correcting rotation in images obtained by a camera assembly is provided. Method 300 may be used to operate a camera assembly, such as the camera assembly 184 of the refrigerator appliance 100 or any other suitable camera assembly for monitoring appliance operation or inventory. In this regard, for example, controller 156 may be configured for implementing method 300. However, it should be appreciated that the exemplary method 300 is discussed herein only to describe exemplary aspects of the present subject matter and is not intended to be limiting to the claimed subject matter.

It is noted that the order of steps within method 300 is for illustrative purposes. All may be adopted or characterized as being fulfilled in a common operation. Except as otherwise indicated, one or more steps in the below method 300 may be changed, rearranged, performed in a different order, or otherwise modified without deviating from the scope of the present disclosure.

At 310, the method 300 includes (e.g., optionally) training an image rotation correction model. The image rotation correction model may be configured for detecting rotation in an image obtained by a camera assembly of the refrigerator appliance. Moreover, the image rotation correction model may further be configured for rotating the image (e.g., according to the detected rotation) to produce a corrected image with approximately zero degrees of rotation. The image rotation correction model may be provided with or may include a machine learning image recognition model (e.g., described in more detail above) that may be actively trained by the appliance with one or more images (e.g., training images), may be supplied with training data from the manufacturer or from another remote source, or may be trained in any other suitable manner. For example, the image rotation correction model may be trained with training images that include varying degrees of rotation relative to a fiducial reference or a predetermined angle in the image. In this regard, training the image rotation correction model may include obtaining one or more training images of the chilled chamber. The one or more training images including a predetermined amount of rotation (e.g., a predetermined number of degrees of rotation or a predetermined class label corresponding to a number of degrees of rotation) relative to a fiducial reference, such as a front edge of a lower bin, a side of the cabinet, a reference marker (e.g., a symbol, a feature, or a mark) on a component disposed within the chilled chamber, or the like in the one or more training images. The one or more training images obtained may be supplied to the image rotation correction model (e.g., stored locally or remotely) from a camera assembly of the refrigerator appliance, from the manufacturer, or from another remote source. For instance, before, during, or after installation of the refrigerator appliance, one or more images including a predetermined amount of rotation (e.g., a predetermined degree of rotation) relative to a fiducial reference within the image, such as a front edge of a lower bin in the chilled chamber, may be obtained.

In addition, training the image rotation correction model may include analyzing the one or more training images, with an image recognition process, such as a machine learning image recognition process and updating a rotation algorithm of the image rotation correction model based on analyzing the one or more training images. For example, the machine learning recognition process may comprise at least one of a convolution neural network (“CNN”), a region-based convolution neural network (“R-CNN”), a deep belief network (“DBN”), or a deep neural network (“DNN”) image recognition process that may be configured for analyzing the training images and updating variables of the rotation algorithm based on the analysis of the training images. In this regard, the image rotation correction model may be capable of accurately and effectively determining rotation in one or more images obtained by a camera assembly and correcting the rotation such that the one or more images include approximately zero degrees of rotation.

At 320, the method 300 includes receiving a door signal corresponding to a door of the refrigerator appliance being in an open position, for instance, during operation of the refrigerator appliance 100. The first door signal may be transmitted from a door position sensor, such as a reed switch, a Hall-effect sensor, or the like, configured for detecting a position of the door. For instance, a user may open the door of the refrigerator appliance to retrieve an item from, or place an item into, the chilled chamber. In such instances, the position sensor may detect when the door is in the open position and transmit the first door signal to the controller of the refrigerator appliance. In some embodiments, transmitting the door signal includes detecting a break in the door signal. For instance, opening the door of the refrigerator appliance may break or interrupt a signal or connection between the door and the cabinet. In this regard, the position sensor may transmit the door signal when the break in the signal is detected.

Additionally or alternatively, receiving the door signal may include includes receiving one or more images for each of a plurality of capture sequences. In other words, at least one image may be received from a plurality of discrete capture sequences. Each capture sequence may be executed at a different point in time. For instance, each image capture sequence may correspond to a unique open-door event or other sequence in which a captured image is occupied (e.g., not blank or entirely black). In exemplary embodiments, the method 300 includes initiating each of the plurality of capture sequences in response to a discrete door opening event. For instance, one or more (e.g., each or some) of the plurality of capture sequences may be an open-door capture sequence. A discrete door opening event may be detected, for instance, based on an image value or a signal from a separate sensor or switch. In turn, the discrete door opening event of each of the plurality of capture sequence may be detected based on an elevated image value in a received static image signal. Additionally or alternatively, the discrete door opening event of each of the plurality of capture sequence may be detected based on receiving an open signal from the door switch.

Generally, the open-door capture sequence may direct images to be captured sequentially at the camera module. For instance, two-dimensional images may be captured at a set sample rate that is greater than the sample rate of the anti-fog capture sequence. The sample rate of the open-door capture sequence may thus be relatively high, such as between 25 frames per second and 120 frames per second. Additionally or alternatively, the sample rate may be greater than or equal to 30 frames per second. Further additionally or alternatively, the sample rate may be around 60 frames per second.

As would be understood in light of the present disclosure, for each capture sequence, one or more two-dimensional images may be captured at a set sample rate (e.g., according to the type of capture sequence being executed). In turn, such two-dimensional images may be recorded (e.g., for analysis or display).

At 330, the method 300 includes obtaining one or more images of the chilled chamber of the refrigerator appliance using a camera assembly, for instance, in response to receiving the door signal. The images obtained by camera assembly may include one or more still images, one or more video clips, or any other suitable type and number of images suitable for detection of motion within the chilled chamber. The camera assembly may obtain images upon any suitable trigger, such as a time-based imaging schedule (e.g., one or more predetermined time intervals) where camera assembly periodically images and monitors fresh food chamber, such as when the door is in the open position.

It should be appreciated that the images obtained by camera assembly may vary in number, frequency, angle, resolution, detail, etc. in order to improve the clarity of objects within the chilled chamber. In addition, according to exemplary embodiments, the controller may be configured for illuminating a refrigerator light while the camera assembly obtains the one or more images. Other suitable triggers are possible and within the scope of the present subject matter.

As explained above, across the life span of the refrigerator appliance, a positioning of the camera of the camera assembly may become misaligned (e.g., unintentionally) relative the cabinet. For example, as explained above, a user may unintentionally manipulate a positioning of the camera relative to the cabinet that alters or misaligns the field of view of the camera (e.g., relative to a fiducial reference or a predetermined angle in the field of view of the camera).

At 340, the method 300 includes determining rotation relative to the fiducial reference or a predetermined angle in the one or more images (e.g., subsequent or in response to 330). In some embodiments, the determination at 340 is based on a rotation algorithm of the image rotation correction model. As mentioned above, the image rotation correction model may include a machine learning image recognition process. In some embodiments determining rotation in the one or more images include processing the one or more images with the machine learning image recognition process to determine rotation in the one or more images. For example, the one or more images may be processed to determine a number of degrees of rotation relative to a fiducial reference in the images or to determine a class label (e.g., “Slightly rotated,” “Fully Rotated” “No Rotation,” etc. corresponding to the number of degrees of rotation). This processing may be performed entirely by the controller, may be offloaded to a remote server for analysis, or may be analyzed in any other suitable manner.

In some embodiments, the rotation may be determined in a horizontal plane of the refrigerator appliance. For instance, the rotation relative to the fiducial reference may be determined in a horizontal plane that extends along or parallel to a shelf positioned within the chilled chamber.

At 350, the method 300 includes generating a corrected image based on determining rotation relative to the fiducial reference or the predetermined angle in the one or more images. Generating the corrected image may include rotating the one or more images based on the determined rotation (e.g., number of degrees of rotation or class label of rotation) relative to the fiducial reference in the one or more images. In some embodiments, rotating the images includes applying a mathematical transformation according to a rotation matrix to pixels of the one or more images relative to the images center. This mathematical transformation may recalculate the position of the pixels based on the desired rotation angle. In particular, the one or more images may be rotated to approximately zero degrees of rotation relative to the fiducial reference. In this regard, for example, the one or more images may be rotated, straightened, modified, or otherwise enhanced to provide proper focus on a region of the chilled chamber. Notably, if the one or more images are not rotated to approximately zero degrees relative to the fiducial reference, contents within the chilled chamber, such as within the lower bin, may not be represented in the images that are eventually transmitted to a user (e.g., as described in more detail below)

At 360, the method 300 includes generating a modified image by cropping the corrected image (e.g., in response to 350). In this regard, for example, the one or more corrected images may be cropped, modified, or otherwise enhanced to provide proper focus on a region of the fresh food chamber that is associated with the camera position. For example, if the camera is in the first position (e.g., associated with the lower shelf), the images may be cropped to generate a modified image or images focusing primarily on lower shelf (e.g., as shown in dotted lines in FIG. 5). By contrast, if the camera is in the second position (e.g., associated with open lower bin), the images may be cropped to generate a modified image or images focusing solely on lower bin (e.g., as shown in dotted lines in FIG. 6) or of left and right portions of the lower bin (e.g., as shown in images 214 and 216 of FIG. 8 that corresponds to left and right portions of the open lower bin depicted in image 204 of FIG. 7). In this manner, a user of refrigerator appliance 100 may customize the images communicated based on their use preference as specified by the camera position.

It should be appreciated that other image modifications may be made while remaining within the scope of the present subject matter. For example, portions of fresh food chamber outside of the desired/target field of view (based on camera position) may be blurred out to focus eyes on the target objects. Alternatively, method 300 may include splicing or merging multiple images of the one or more obtained images to provide the best modified image representation of the target field of view or the desired objects.

At 370, the method 300 includes transmitting an image notification to a user interface associated with the refrigerator appliance in response to generating the modified image. The image notification may correspond to or may include the modified image generated. For example, the image notification may be transmitted to a user interface integrated into the refrigerator appliance, such as control panel of the refrigerator appliance. In such instances, the image notification may be displayed on a display of the control panel. As another example, the image notification may be transmitted to a remote user interface, such as a remote device (e.g., through a software application on the user's cell phone) in operative communication with the controller over network. In yet some other embodiments, the image notification may provide a user with details related to the modified image, such as an identification of a storage features, such as a storage bin or drawer disposed within the chilled chamber, identification of an object within the modified image, a location of the object, an expiration date of the object, or any other suitable qualitative or quantitative information related to the object.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a camera assembly mounted to the cabinet; and
a controller operably coupled to the camera assembly, the controller operable for:
obtaining one or more images of the chilled chamber using the camera assembly,
determining rotation relative to a fiducial reference of the refrigerator appliance in the one or more images, and
generating a corrected image based on determining rotation relative to the fiducial reference in the one or more images.

2. The refrigerator appliance of claim 1, wherein the image rotation correction model comprises a machine learning image recognition process, and
wherein determining rotation relative to the fiducial reference in the one or more images comprises processing the one or more images with the machine learning image recognition process to determine a number of degrees of rotation relative to the fiducial reference in the one or more images.

3. The refrigerator appliance of claim 2, wherein the machine learning image recognition process comprises at least one of a convolution neural network (“CNN”), a region-based convolution neural network (“R-CNN”), a deep belief network (“DBN”), or a deep neural network (“DNN”) image recognition process.

4. The refrigerator appliance of claim 2, wherein generating the corrected image comprises rotating the one or more images based on the determining rotation relative to the fiducial reference in the one or more images.

5. The refrigerator appliance of claim 4, wherein rotating the one or more images comprises rotating the one or more images to zero degrees of rotation relative to the fiducial reference or a predetermined angle within the one or more images.

6. The refrigerator appliance of claim 1, wherein the controller is further operable for:
training the image rotation correction model prior to obtaining one or more images of the chilled chamber.

7. The refrigerator appliance of claim 6, wherein training the image rotation correction model comprises
obtaining one or more training images comprising a predetermined number of degrees of rotation relative to the fiducial reference,
analyzing the one or more training images with a machine learning image recognition process, and
updating the image rotation correction model based on analyzing the one or more training images.

8. The refrigerator appliance of claim 1, further comprising:
a door being rotatably mounted to the cabinet to provide selective access to the chilled chamber,
wherein the controller is further operable for:
receiving a door signal corresponding to the door being in an open position,
wherein obtaining one or more images of the chilled chamber using the camera assembly is in response to receiving the door signal.

9. The refrigerator appliance of claim 1, wherein the controller is further operable for:
generating a modified image by cropping the corrected image.

10. The refrigerator appliance of claim 9, transmitting an image notification to a user interface associated with the refrigerator appliance in response to generating the modified image.

11. A method for correcting rotation in images obtained by a camera assembly of a refrigerator appliance, the method comprising:
obtaining one or more images of a chilled chamber of the refrigerator appliance using the camera assembly,
determining rotation relative to a fiducial reference of the refrigerator appliance in the one or more images, and
generating a corrected image based on determining rotation relative to the fiducial reference in the one or more images.

12. The method of claim 11, wherein the image rotation correction model comprises a machine learning image recognition process, and
wherein determining rotation in the one or more images comprises processing the one or more images with the machine learning image recognition process to determine a number of degrees of rotation relative to the fiducial reference in the one or more images.

13. The method of claim 12, wherein the machine learning image recognition process comprises at least one of a convolution neural network (“CNN”), a region-based convolution neural network (“R-CNN”), a deep belief network (“DBN”), or a deep neural network (“DNN”) image recognition process.

14. The method of claim 12, wherein generating the corrected image comprises rotating the one or more images based on the determining rotation relative to the fiducial reference in the one or more images.

15. The method of claim 14, wherein rotating the one or more images comprises rotating the one or more images to zero degrees of rotation relative to the fiducial reference or a predetermined angle within the image.

16. The method of claim 11, further comprising:
training the image rotation correction model prior to obtaining one or more images of the chilled chamber.

17. The method of claim 16, wherein training the image rotation correction model comprises
obtaining one or more training images comprising a predetermined number of degrees of rotation relative to the fiducial reference,
analyzing the one or more training images with a machine learning image recognition process, and
updating the image rotation correction model based on analyzing the one or more training images.

18. The method of claim 11, further comprising:
receiving a door signal corresponding to a door being in an open position,
wherein obtaining one or more images of the chilled chamber using the camera assembly is in response to receiving the door signal.

19. The method of claim 11, further comprising:
generating a modified image by cropping the corrected image.

20. The method of claim 19, further comprising:
transmitting an image notification to a user interface associated with the refrigerator appliance in response to generating the modified image.
